(19) United States
(12) Patent Application Publication
(10) Pub. No.: US 2012/0120084 A1
(43) Pub. Date: May 17, 2012

(54) COLOR FILTER ARRANGEMENT FOR DISPLAY PANEL

(75) Inventors: Yuet Wing Li, Tainan County (TW); Kuan-Hsu Fan-Chiang, Tainan County (TW); Chien-Tang Wang, Tainan County (TW)

(73) Assignee: Himax Display, Inc., Tainan County (TW)

(21) Appl. No.: 12/945,371

(22) Filed: Nov. 12, 2010

(51) Int. Cl. G09G 5/02

(52) U.S. Cl. 345/589

(57) ABSTRACT

A color filter arrangement for a display panel is provided. The display panel includes a first pixel and a second pixel. The first pixel includes a plurality of first sub-pixels with different colors. The second pixel includes a plurality of second sub-pixels with different colors. A first edge sub-pixel of the first sub-pixels is adjacent to (neighbor on) a second edge sub-pixel of the second sub-pixels. The first edge sub-pixel and the second edge sub-pixel have a same color.

### BACKGROUND

1. Field of the Invention

The invention relates to a display panel. More particularly, the invention relates to a color filter arrangement for a display panel.

2. Description of Related Art

FIG. 1 is a diagram illustrating a conventional color filter arrangement for a display panel 100. The display panel 100 has a plurality of pixels, for example, a pixel 120 and a pixel 130. Each pixel has a plurality of sub-pixels with different colors. According to the conventional color filter arrangement, each pixel has a same color arrangement. For example, if the pixel 120 has three sub-pixels with colors of “green, blue and red” that are arranged in a straight line, the pixel 130 and the other pixels also respectively have three sub-pixels with colors of “green, blue and red” that are arranged in a straight line.

It is always a technical issue in the art to increase a resolution of the display panel. Under a development trend of continually increasing the resolution of the display panel 100, a sub-pixel size and spacing are accordingly decreased. However, due to a fringing field effect of two adjacent (or neighbor) pixels, as the resolution is increased (or the sub-pixel size is decreased), a color gamut of the display panel 100 is accordingly decreased. Estimation of the color gamut is generally performed based on a color gamut customized by a national television standards committee (NTSC), and percentage (%) is used as a unit of the color gamut.

A region 110 shown in FIG. 1 is an adjacent edge region of the pixels 120 and 130. Assuming in a certain image frame, a green sub-pixel 131 in the pixel 130 is not supposed to present a green light, though due to the fringing field effect, a driving electric field of a red sub-pixel 121 in the pixel 120 probably influences the pixel 130 to cause a green light leakage of the adjacent green sub-pixel 131. Generally, the smaller the sub-pixel size is, or the smaller the sub-pixel spacing is, or the greater a distance between an upper and a lower electrode plates in the sub-pixel is, the severe the fringing field effect is. Especially, the fringing field effect is more obvious for a high-intensity projection display panel such as a liquid crystal on silicon (LCOS) panel, etc.

For example, FIG. 2 is a schematic diagram illustrating a relationship between sub-pixel sizes of the LCOS panel and color gamut thereof. In FIG. 2, a vertical axis represents color gamut of the LCOS panel, a horizontal axis represents sub-pixel sizes of the LCOS panel, and a curve 210 represents a relationship curve between the sub-pixel sizes and the color gamut thereof. According to FIG. 2, it is known that the smaller the sub-pixel size is, the severe the fringing field effect is, and the smaller the color gamut of the LCOS panel is. For example, if the sub-pixel size of the LCOS panel is 18 μm×18 μm, the color gamut of the LCOS panel is about 34%, and if the sub-pixel size of the LCOS panel is reduced to 12.6 μm×12.6 μm, the color gamut of the LCOS panel is then reduced to about 31%.

### SUMMARY OF THE INVENTION

The invention is directed to a color filter arrangement for a display panel. Compared to a same color gamut performance of a conventional color filter arrangement, the color filter arrangement of the invention can further reduce a sub-pixel size to increase a resolution of the display panel. Alternatively, compared to a same resolution of the conventional color filter arrangement, the color filter arrangement of the invention can improve a color gamut performance of the display panel.

An embodiment of the invention provides a color filter arrangement for a display panel. The display panel includes a first pixel and a second pixel. The first pixel includes a plurality of first sub-pixels with different colors. The second pixel includes a plurality of second sub-pixels with different colors. At least a first edge sub-pixel of the first sub-pixels is adjacent to a second edge sub-pixel of the second sub-pixels along a first direction, and the first edge sub-pixel and the second edge sub-pixel all have a first color.

According to the above descriptions, in two adjacent pixels, the sub-pixels with the same color are arranged adjacent to each other. For example, assuming the first edge sub-pixel in the first pixel is adjacent to the second edge sub-pixel in the second pixel, the first and the second edge sub-pixels are arranged to have a same color. Therefore, even if a driving electric field of the first edge sub-pixel influences the second edge sub-pixel to cause a light leakage of the adjacent second edge sub-pixel, since the colors of the first and the second edge sub-pixels are the same, an influence of a fringing field effect to the color gamut performance can be mitigated.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a conventional color filter arrangement for a display panel.

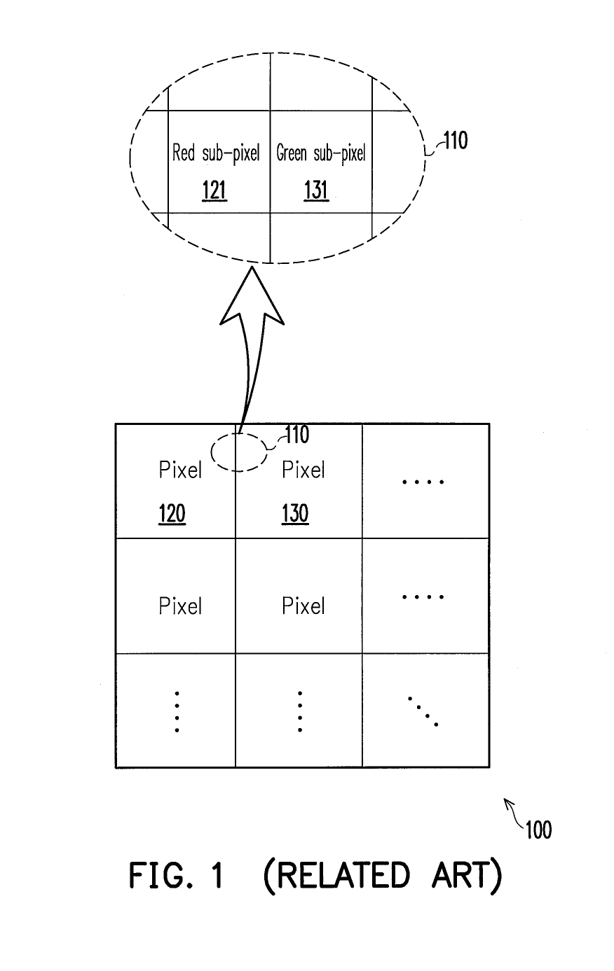

FIG. 2 is a schematic diagram illustrating a relationship between sub-pixel sizes of a liquid crystal on silicon (LCOS) panel and color gamut thereof.

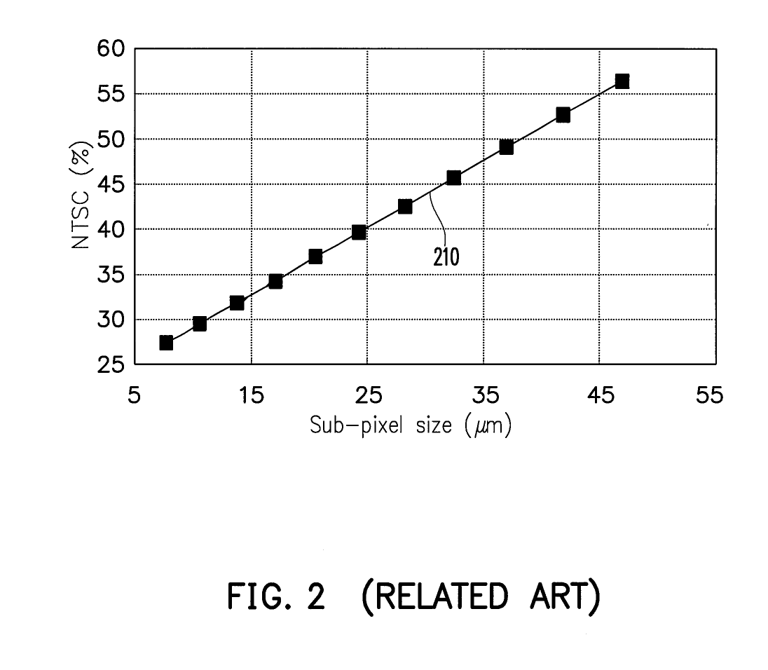

FIG. 3 is a schematic diagram illustrating a color filter arrangement for a display panel according to an embodiment of the invention.

FIG. 4 is a schematic diagram illustrating a color filter arrangement for a display panel according to another embodiment of the invention.

FIG. 5 is a schematic diagram illustrating a relationship between color gamut of a LCOS panel of FIG. 4 and sub-pixel sizes thereof according to an embodiment of the invention.

FIG. 6 is a schematic diagram illustrating a color filter arrangement for a display panel according to still another embodiment of the invention.

### DETAILED DESCRIPTION OF DISCLOSED EMBODIMENTS

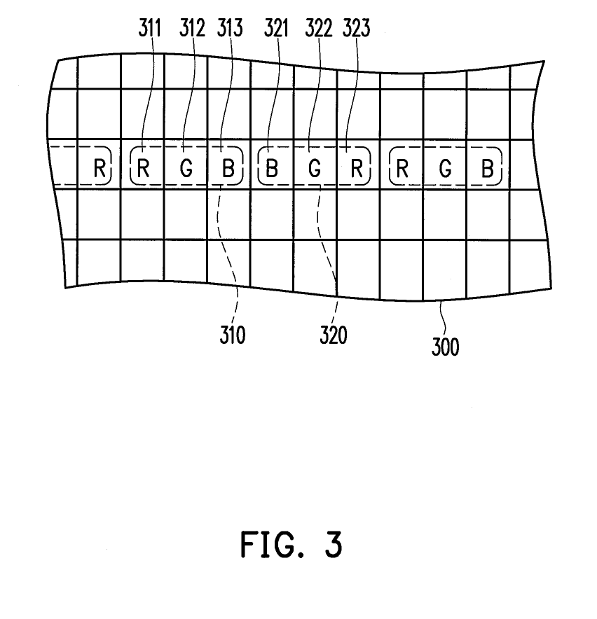

FIG. 3 is a schematic diagram illustrating a color filter arrangement for a display panel according to an embodiment of the invention. Referring to FIG. 3, the display panel 300 includes a plurality of pixels, for example, a first pixel 310 and a second pixel 320 shown in FIG. 3. The first pixel 310 is adjacent to the second pixel 320, and the first pixel 310 and the second pixel 320 are all located on a same scan line.

The first pixel 310 includes a plurality of first sub-pixels with different colors, for example, first sub-pixels 311, 312 and 313 respectively having colors of red (R), green (G) and blue (B) shown in FIG. 3. The second pixel 320 includes a plurality of second sub-pixels with different colors, for example, second sub-pixels 321, 322 and 323 respectively having colors of blue, green and red shown in FIG. 3. Here, the first sub-pixel 313 in the first sub-pixels 311-313 that is adjacent to the second pixel 320 is referred to as a first edge sub-pixel, and the second sub-pixel 321 in the second sub-pixels 321-323 that is adjacent to the first pixel 310 is referred to as a second edge sub-pixel. Since the first edge sub-pixel 313 and the second edge sub-pixel 321 have a same color (for example, a blue color), even if a driving electric field of the first edge sub-pixel 313 influences the second edge sub-pixel 321 due to a fringing field effect, the second edge sub-pixel 321 does not leak light of other colors (for example, a none blue color light), so that an influence of the fringing field effect to a color gamut performance can be mitigated.

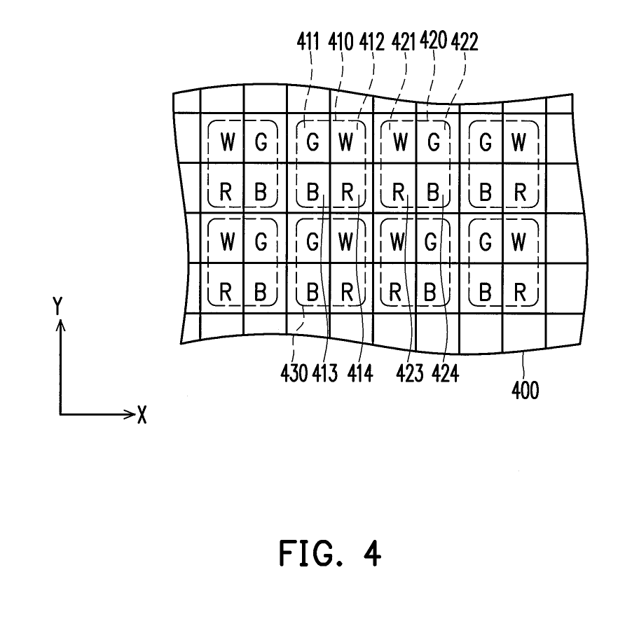

FIG. 4 is a schematic diagram illustrating a color filter arrangement for a display panel according to another embodiment of the invention. Referring to FIG. 4, the display panel 400 includes a plurality of pixels, for example, a first pixel 410 and a second pixel 420 shown in FIG. 4. The first pixel 410 is adjacent to the second pixel 420 along a first direction (for example, an X-axis direction, or a scan line direction). In the present embodiment, the first pixel 410 and the second pixel 420 are respectively a 2×2 sub-pixel array. The first pixel 410 includes a plurality of first sub-pixels 411, 412, 413 and 414 with different colors, and the second pixel 420 includes a plurality of second sub-pixels 421, 422, 423 and 424 with different colors. The sub-pixels 411, 412, 421 and 422 are disposed on a same scan line, and the sub-pixels 413, 414, 423 and 424 are disposed on another scan line.

If the display panel 400 is applied to a reflective display panel (for example, a liquid crystal on silicon (LCOS) panel, to increase brightness, white sub-pixels can be disposed in the pixels. For example, colors of the first sub-pixels 411-414 of FIG. 4 are respectively green, white (W), blue and red. Colors of the second pixels 421-424 are respectively white, green, red and blue. In the present embodiment, the first sub-pixels 412 and 414 in the first sub-pixels 411-414 that are adjacent to the second pixel 420 are respectively referred to as a first edge sub-pixel and a third edge sub-pixel, and the second sub-pixels 421 and 423 in the second sub-pixels 421-424 that are adjacent to the first pixel 410 are respectively referred to as a second edge sub-pixel and a fourth edge sub-pixel.

Since the first edge sub-pixel 412 and the second edge sub-pixel 421 all have a same color (for example, the white color), even if a driving electric field of the first edge sub-pixel 412 influences the second edge sub-pixel 421 due to the fringing field effect, the second edge sub-pixel 421 does not leak light of other colors (for example, a none white color light). Similarly, since the third edge sub-pixel 414 and the fourth edge sub-pixel 423 all have a same color (for example, the red color), even if a driving electric field of the third edge sub-pixel 414 influences the fourth edge sub-pixel 423 due to the fringing field effect, the fourth edge sub-pixel 423 does not leak light of other colors (for example, a none red color light). Therefore, an influence of the fringing field effect to the color gamut performance can be mitigated.

Due to an internal structure of the display panel, the fringing field effect along a second direction (for example, a Y-axis direction, or a data line direction) is relatively not obvious, so that pixels adjacent along the second direction may have the same color filter arrangement. For example, a third pixel 430 is adjacent to the first pixel 410 along the second direction, so that the color filter arrangement of the third pixel 430 is the same to that of the first pixel 410.

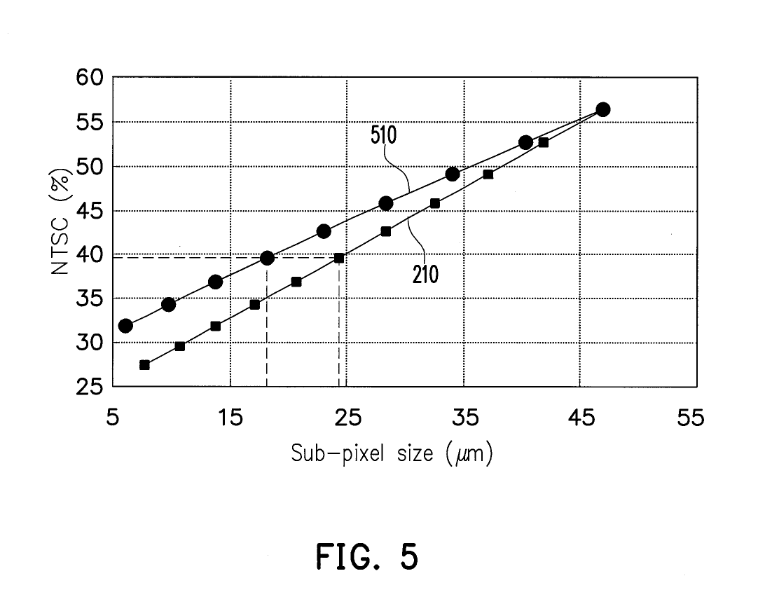

FIG. 5 is a schematic diagram illustrating a relationship between color gamut of the LCOS panel 400 of FIG. 4 and sub-pixel sizes thereof according to an embodiment of the invention. In FIG. 5, a vertical axis represents color gamut of the LCOS panel, a horizontal axis represents sub-pixel sizes of the LCOS panel, and a feature curve 510 represents a relationship curve between the sub-pixel sizes of the display panel 400 and the color gamut thereof. According to a feature curve 210 of the conventional color filter arrangement and the feature curve 510 of the color filter arrangement of the present embodiment of FIG. 5, compared to a same color gamut performance of the conventional color filter arrangement, the color filter arrangement of the invention can further reduce the sub-pixel size to increase a resolution of the display panel. For example, in case of a color gamut of 40%, a sub-pixel size of the conventional color filter arrangement can be reduced to 24 μm×24 μm at most, while the sub-pixel size of the color filter arrangement of the present invention can be further reduced to 17.5 μm×17.5 μm. Therefore, the resolution of the display panel of the invention can be increased. Alternatively, compared to a same resolution of the conventional color filter arrangement, the color filter arrangement of the invention can improve the color gamut performance of the display panel.

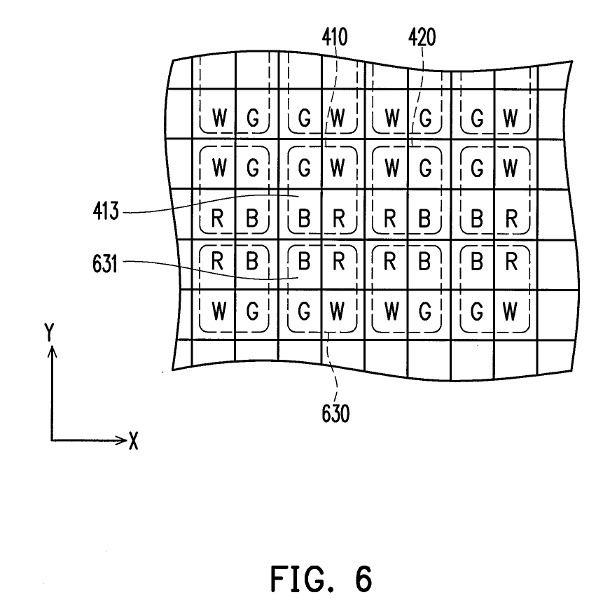

In the display panel 400 of the above embodiment, pixels adjacent along the second direction (the Y-axis direction or the data line direction) may have the same color filter arrangement, though the invention is not limited thereto. For example, FIG. 6 is a schematic diagram illustrating a color filter arrangement for a display panel according to still another embodiment of the invention. Referring to FIG. 6, the display panel 600 includes a plurality of pixels, for example, the first pixel 410, the second pixel 420 and a third pixel 630 shown in FIG. 6. Description of the first pixel 410 and the second pixel 420 can refer to the related description of FIG. 4. The third pixel 630 includes a plurality of third sub-pixels with different colors, wherein at least one fifth edge sub-pixel 631 in the third sub-pixels is adjacent to a sixth edge sub-pixel 413 in the first sub-pixels 411-414 along the second direction (the Y-axis direction or the data line direction), and the fifth edge sub-pixel 631 and the sixth edge sub-pixel 413 all have the same color (for example, the blue color).

In summary, in two adjacent pixels of the above embodiments, the sub-pixels with the same color are arranged adjacent to each other. For example, assuming the first edge sub-pixel in the first pixel is adjacent to the second edge sub-pixel in the second pixel, the first and the second edge sub-pixels are arranged to have a same color. If the sub-pixel 313 of FIG. 3, the sub-pixel 412 of FIG. 4 or the sub-pixel 413 of FIG. 6 is taken as the aforementioned first edge sub-pixel, the aforementioned second edge sub-pixel can be the sub-pixel 321 of FIG. 3, the sub-pixel 421 of FIG. 4 or the sub-pixel 631 of FIG. 6. Therefore, even if the driving electric field of the first edge sub-pixel influences the second edge sub-pixel to cause a light leakage of the second edge sub-pixel, since the colors of the first and the second edge sub-pixels are the same, an influence of the fringing field effect to the color gamut performance can be mitigated.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A color filter arrangement for a display panel, comprising:
a first pixel, comprising a plurality of first sub-pixels with different colors; and
a second pixel, comprising a plurality of second sub-pixels with different colors, wherein at least a second edge sub-pixel of the second sub-pixels is adjacent to a first edge sub-pixel of the first sub-pixels along a first direction, and the first edge sub-pixel and the second edge sub-pixel all have a first color.

2. The color filter arrangement as claimed in claim 1, wherein the first color is a red color, a green color, a blue color or a white color.

3. The color filter arrangement as claimed in claim 1, wherein the first pixel and the second pixel are respectively a 2×2 sub-pixel array.

4. The color filter arrangement as claimed in claim 1, wherein a third edge sub-pixel of the first sub-pixels is adjacent to a fourth edge sub-pixel of the second sub-pixels, and the third edge sub-pixel and the fourth edge sub-pixel all have a second color.

5. The color filter arrangement as claimed in claim 1, wherein the first edge sub-pixel and the second edge sub-pixel are all disposed on a same scan line.

6. The color filter arrangement as claimed in claim 1, further comprising:
a third pixel, comprising a plurality of third sub-pixels with different colors, wherein at least a fifth edge sub-pixel of the third sub-pixels is adjacent to a sixth edge sub-pixel of the first sub-pixels along a second direction, and the fifth edge sub-pixel and the sixth edge sub-pixel all have a third color.

7. The color filter arrangement as claimed in claim 1, further comprising:
a third pixel, adjacent to the first pixel along a second direction, wherein color filter arrangements of the first pixel and the third pixel are the same.
